(19) United States
(12) Patent Application Publication
(10) Pub. No.: US 2012/0169273 A1
(43) Pub. Date: Jul. 5, 2012

(54) Electronic Device, Charging Device and Electronic Device Module Using the Same

(75) Inventors: Wei-Yu Liu, New Taipei City (TW); Chien-Chiang Huang, Taoyuan City (TW); Tai-Li Su, New Taipei City (TW); Huang-Fu Lin, Taoyuan City (TW)

(73) Assignee: Quanta Computer, Inc., Tao Yuan Shien (TW)

(21) Appl. No.: 13/209,168

(22) Filed: Aug. 12, 2011

(30) Foreign Application Priority Data
Dec. 30, 2010 (TW) 099146975

(51) Int. Cl. H02J 7/00

(52) U.S. Cl. 320/107

(57) ABSTRACT

An electronic device, a charging device and an electronic device module using the same are provided. The electronic device is adapted to a charging device for charging. The charging device comprises a first charging electrode and a second charging electrode. The electronic device comprises a main machine, a first device electrode and a second device electrode. The main machine has a display surface and a charging surface opposite to the display surface. The first device electrode and the second device electrode are both located on the charging surface. The main machine is charged in such way that the first device electrode placed on one of the first charging electrode and the second charging electrode and the second device electrode placed on the other of the first charging electrode and the second charging electrode.

This application claims the benefit of Taiwan application Serial No. 99146975, filed Dec. 30, 2010, the subject matter of which is incorporated herein by reference.

### BACKGROUND OF THE INVENTION

1. Field of the Invention

The invention relates in general to an electronic device, a charging device and an electronic device module using the same, and more particularly to an electronic device convenient for charging, the charging device and an electronic device module using the same.

2. Description of the Related Art

Conventional electronic device comprises a main machine and a power storage unit, so that a fully charged electronic device can work without external power. The main machine has an indented portion, and the charging base has a corresponding protruded electrode. By implanting the protruded electrode of the charging base to the indented portion of the electronic device, the charging base transmits the external power to the power storage unit of the electronic device.

During the implantation process, the indented portion of the electronic device must be accurately aligned with the protruded electrode of the charging base. In addition, the indented portion of the electronic device and the protruded electrode of the charging base normally have smaller dimensions, making the implantation process more inconvenient.

### SUMMARY OF THE INVENTION

The invention is directed to an electronic device, a charging device and an electronic device module using the same. The electronic device starts to be charged when placed on the charging device. The process of placing the electronic device does not require alignment accuracy, and the preceding operation of the electrical contact between the electronic device and the charging device can thus be omitted.

According to a first aspect of the present invention, an electronic device is provided. The electronic device is adapted to a charging device for charging. The charging device comprises a first charging electrode, a second charging electrode and a placement surface. The electronic device comprises a main machine, a first device electrode and a second device electrode. The main machine has a display surface and a charging surface opposite to the display surface. The first device electrode having a first polarity is located on the charging surface. The second device electrode having a second polarity is located on the charging surface. The main machine is charged in such way that the first device electrode placed on one of the first charging electrode and the second charging electrode and the second device electrode placed on the other of the first charging electrode and the second charging electrode.

According to a second aspect of the present invention, a charging device is provided. The charging device is for providing a power to an electronic device. The electronic device comprises a main machine, a first device electrode and a second device electrode. The main machine has a display surface and a charging surface opposite to the display surface. The first device electrode and the second device electrode are both located on the charging surface. The charging device comprises a body, a first charging electrode and a second charging electrode. The body has a placement surface for receiving the electronic device. The first charging electrode is located within the placement surface of the body. The second charging electrode is located within the placement surface of the body. The main machine is charged in such way that the first device electrode placed on one of the first charging electrode, and the second charging electrode and the second device electrode placed on the other of the first charging electrode and the second charging electrode.

According to a third aspect of the present invention, an electronic device module is provided. The electronic device module comprises a charging device and an electronic device. The electronic device comprises a main machine, a first device electrode and a second device electrode. The main machine has a display surface and a charging surface opposite to the display surface. The first device electrode is located on the charging surface. The second device electrode is located on the charging surface. The charging device comprises a body, a first charging electrode and a second charging electrode. The body has a placement surface for receiving the electronic device. The first charging electrode is located within the placement surface of the body. The second charging electrode is located within the placement surface of the body. The main machine is charged in such way that the first device electrode placed on one of the first charging electrode and the second charging electrode and the second device electrode placed on the other of the first charging electrode and the second charging electrode.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a bottom view of an electronic device according to an exemplary embodiment of the invention;

FIG. 2 shows a top view of a charging device according to an exemplary embodiment of the invention;

FIG. 3 shows a top view of the electronic device of FIG. 1 being placed on the charging device of FIG. 2;

FIG. 4 shows a cross-sectional view along direction 4-4′ of FIG. 3;

FIG. 5 shows a cross-sectional view along direction 5-5′ of FIG. 1;

FIG. 6 shows a cross-sectional view along direction 6-6′ of FIG. 2;

FIG. 7 shows a top view of the electronic device of FIG. 3 being moved to a second boundary of a placement surface;

FIG. 8 shows a bottom view of an electronic device according to an embodiment of the invention;

FIG. 9 shows a top view of a charging device according to an embodiment of the invention;

FIG. 10 shows a charging device according to an embodiment of the invention;

FIG. 11 shows a top view of the electronic device of FIG. 3 being moved to a third boundary of a placement surface;

FIG. 12 shows a top view of the electronic device of FIG. 11 being moved to a fourth boundary of a placement surface; and

FIG. 13 shows another placement of the electronic device of FIG. 3.

### DETAILED DESCRIPTION OF THE INVENTION

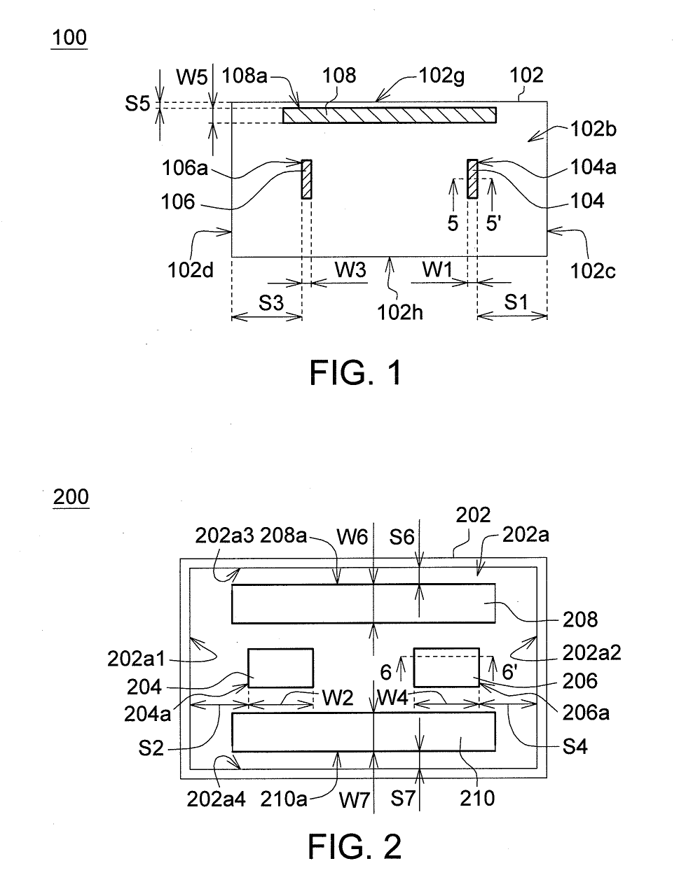

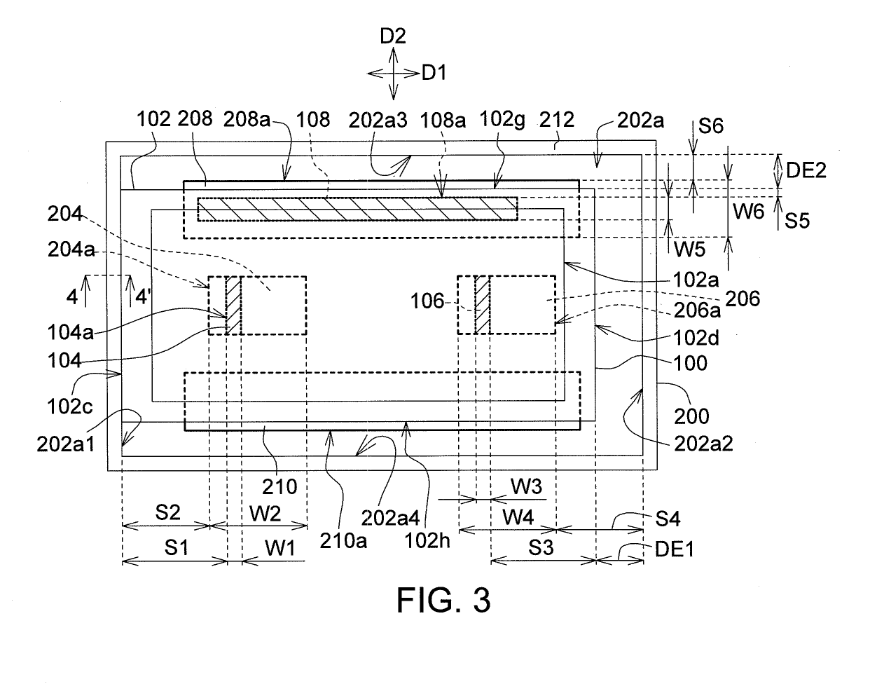

Referring to FIGS. 1˜3. FIG. 1 shows a bottom view of an electronic device according to an exemplary embodiment of the invention. FIG. 2 shows a top view of a charging device according to an exemplary embodiment of the invention. FIG. 3 shows a top view of the electronic device of FIG. 1 being placed on the charging device of FIG. 2. The electronic device 100 can be realized by such as a flat computer, a mobile phone, a personal digital assistant (PDA), other electronic devices or other portable electronic devices.

As indicated in FIG. 1, the electronic device 100 comprises a main machine 102, a first device electrode 104, a second device electrode 106 and a third device electrode 108. The main machine 102 has a display surface 102a (illustrated in FIG. 3), charging surface 102b opposite to the display surface 102a, a first main machine lateral surface 102c and a second main machine lateral surface 102d opposite to the first main machine lateral surface 102c. The charging surface 102b is such as disposed on the back surface of the main machine 102 and connected to the first main machine lateral surface 102c and the second main machine lateral surface 102d. The first device electrode 104 and the second device electrode 106 are located on the charging surface 102b, and are separated from each other. The display surface 102a is such as disposed on the front surface of the main machine 102. The electronic device 100 further comprises a display module (not illustrated) having a surface as the display surface 102a for displaying various information such as charging progress or percentage.

As indicated in FIG. 2, the charging device 200 comprises a body 202, a first charging electrode 204 and a second charging electrode 206. The body 202 has a placement surface 202a, such as an outer surface of the body 202 on which the electronic device 100 is placed for charging. The first charging electrode 204, the second charging electrode 206, the first detection electrode 208 and the second detection electrode 210 are located within the placement surface 202a of the body 202. The first charging electrode 204 and the second charging electrode 206 are separated from each other. The first detection electrode 208 and the second detection electrode 210 are separated from each other. When the charging surface 102b of the electronic device 100 is placed on the charging device 200, the main machine 102 is charged in such way that the first device electrode 104 placed on one of the first charging electrode 204 and the second charging electrode 206 and the second device electrode 106 placed on the other of the first charging electrode 204 and the second charging electrode 206 as indicated in FIG. 3. In addition, the main machine 102 further comprises a power storage unit (not illustrated) electrically connected to the first device electrode 104 and the second device electrode 106 for storing power.

In one embodiment, the charging surface 102b of the electronic device 100 is the one with a relative larger area selected among all outer surfaces of the main machine 102, and is such as the back surface with the largest area. The placement surface 202a of the charging device 200 is a surface with a relative larger area selected among all outer surfaces of the body 202, and is such as the top surface with the largest area. Through the design in the dimensions and circuit of the elements of the charging surface 102b and the placement surface 202a, the charging surface 102b of the electronic device 100 can electrically contact the placement surface 202a of the charging device 200 for charging the electronic device 100 by placing the electronic device 100 on the placement surface 202a without accurate alignment.

As indicated in FIG. 3, the charging device 200 further comprises a bounding box 212 which surrounds the placement surface 202a for limiting the electronic device 100 to be placed within the range of the placement surface 202a.

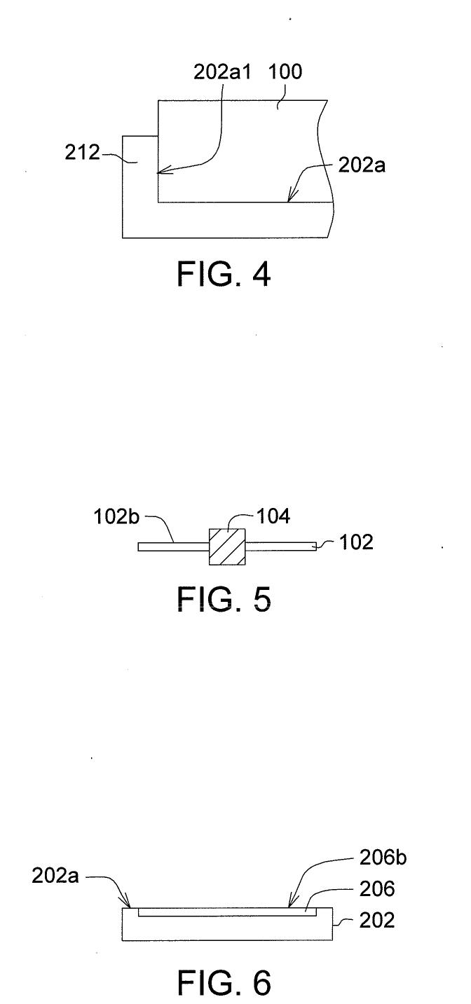

Referring to FIG. 4, a cross-sectional view along direction 4-4′ of FIG. 3 is shown. The bounding box 212 has an inner lateral surface or a first boundary 202a1. When the electronic device 100 is placed on the placement surface 202a, the electronic device 100 is blocked by the inner lateral surface 202a1 and will not move outside the range of the placement surface 202a. However, such exemplification is not for limiting the invention. In an implementation, the charging device 200 still can charge the electronic device 100 placed on the placement surface 202a despite the bounding box 212 is omitted in the charging device 200.

The bounding box has several implementations and is not limited to the implementation illustrated in FIG. 3. In the present embodiment of the invention, the bounding box 212 exemplified by one single closed ring-shaped flange. In other implementations, the bounding box 212 can also be realized by a plurality of separate bar-shaped flanges or a plurality of separate bumps.

Preferably but not restrictively, in the part of the electronic device, at least one of the first device electrode, the second device electrode and the third device electrode is protruded from the charging surface.

Referring to FIG. 5, a cross-sectional view along direction 5-5′ of FIG. 1 is shown. The first device electrode 104 is protruded from the charging surface 102b. Besides, the second device electrode 106 and the third device electrode 108 can also be protruded from the charging surface 102b.

The first device electrode 104, the second device electrode 106 and the third device electrode 108 can be electrically connected to any circuit board (not illustrated) of the main machine 102 or to the power storage unit (not illustrated).

The device electrode and the main machine can be integrally formed in one piece. For example, the first device electrode 104 and the main machine 102 can be integrally formed in one piece in the same manufacturing process by such as double injection molding technology. The device electrodes 106 and 108 can be formed in a manner similar to that of the first device electrode 104.

Preferably but not restrictively, in the part of the charging device, at least one of the first charging electrode, the second charging electrode, the first detection electrode and the second detection electrode is aligned with the placement surface.

Referring to FIG. 6, a cross-sectional view along direction 6-6′ of FIG. 2 is shown. The top surface 206b of the second charging electrode 206 is basically aligned with the placement surface 202a. In addition, the top surface of the first charging electrode 204, the top surface of the first detection electrode 208 and the top surface of the second detection electrode 210 can also be basically aligned with the placement surface 202a.

The charging electrode of the charging device, the device electrode of the electronic device and the detection electrode of the charging device are all formed by a conductive material. For example, the first charging electrode 204, the second charging electrode 206, the first device electrode 104, the second device electrode 106, the third device electrode 108, the first detection electrode 208 and the second detection electrode 210 are formed by such as a conductive rubber.

Referring to FIG. 3. In a practical embodiment, the area of the placement surface 202a of the charging device 200 is larger than the outer dimensions of the electronic device 100. Therefore, the user only needs to place the electronic device 100 on the placement surface 202a, and the electronic device 100 will easily fall within the range of the placement surface 202a without accurately align through the pins as required by conventional charging mechanism.

The following disclosure shows that when the electronic device 100 is located on the placement surface 202a, the device electrodes of the electronic device 100 maintain to electrically contact with the charging electrodes of the charging device 200 regardless the electronic device 100 is located at whatever region of the placement surface 202a. Referring to FIGS. 1˜3. Let the mechanism of electrical contact between the first device electrode 104 and the first charging electrode 204 be taken for example. The first device electrode 104 disposed adjacent to the first main machine lateral surface 102c has a first width W1 and a first device electrode lateral surface 104a which faces the first main machine lateral surface 102c. The first device electrode lateral surface 104a is separated from the first main machine lateral surface 102c by a first distance S1. The length of the placement surface 202a along a first direction D1 (that is, the length direction of the main machine in the present embodiment of the invention as indicated in FIG. 3) differs with the length of the main machine 102 along the first direction D1 by a first difference DE1. The placement surface 202a has a first boundary 202a1 and a second boundary 202a2 opposite to the first boundary 202a1. The first charging electrode 204 disposed adjacent to the first boundary 202a1 has a second width W2 and a first charging electrode lateral surface 204a which faces the first boundary 202a1. The first charging electrode lateral surface 204a is separated from the first boundary 202a1 by a second distance S2. The second distance S2 is smaller than the sum of the first distance S1 and the first width W1 of the first device electrode 104. The sum of the second distance S2 and the second width W2 is larger than the sum of the first difference DE1 and the first distance S1. The above relationships are expressed in formulas (1) and (2) as follows:

S2<W1+S1 (1)

S2+W2>DE1+S1 (2)

When the dimension relationship of formula (1) is satisfied, it can be assured that the first device electrode 104 still maintains electrical contact with the first charging electrode 204, and will not be electrically separated from the first charging electrode 204 despite the first main machine lateral surface 102c of the electronic device 100 is aligned with the first boundary 202a1 of the placement surface 202a.

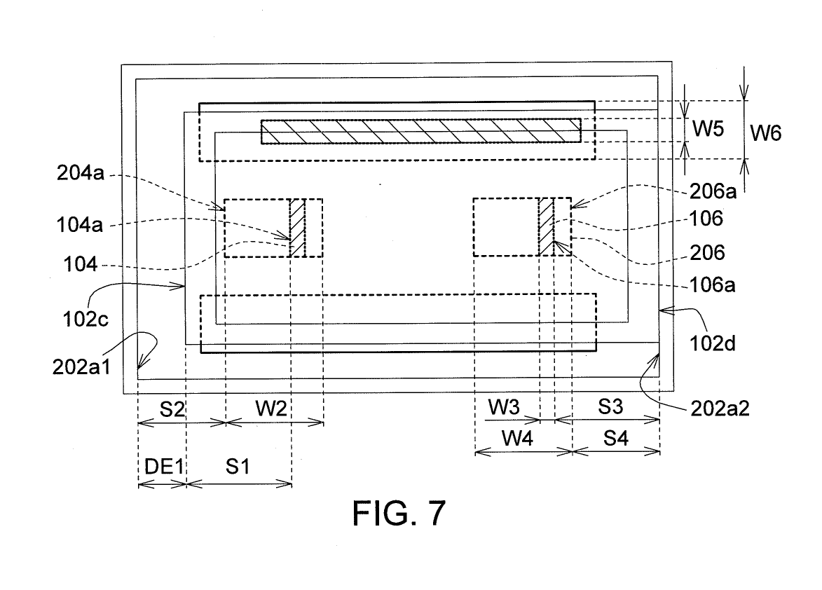

As indicated in FIG. 7, a top view of the electronic device of FIG. 3 being moved to a second boundary of a placement surface is shown. When the dimension relationship of formula (2) is satisfied, it can be assured that the first device electrode 104 still maintains electrical contact with the first charging electrode 204, and will not be electrically separated from the first charging electrode 204 despite the second main machine lateral surface 102d of the electronic device 100 is aligned with the second boundary 202a2 of the placement surface 202a To summarize, when the formulas (1) and (2) are satisfied, the first device electrode 104 still maintains electrical contact with the first charging electrode 204 no matter the first device electrode 104 of the electronic device 100 is moved to whatever position along the first direction D1.

Likewise, the second device electrode 106 still maintains electrical contact with the second charging electrode 206 no matter the second device electrode 106 of the electronic device 100 is moved to whatever position along the first direction D1.

As indicated in FIG. 7, the second device electrode 106 disposed adjacent to the second main machine lateral surface 102d has a third width W3 and a second device electrode lateral surface 106a which faces the second main machine lateral surface 102d. The second device electrode lateral surface 106a is separated from the second main machine lateral surface 102d by a third distance S3. The second charging electrode 206 disposed adjacent to the second boundary 202a2 has a fourth width W4 and a second charging electrode lateral surface 206a which faces the second boundary 202a2. The second charging electrode lateral surface 206a is separated from the second boundary 202a2 by a fourth distance S4. The fourth distance S4 is smaller than the sum of the third distance S3 and the third width W3 of the second device electrode 106. The sum of the fourth distance S4 and the fourth width W4 is larger than the sum of the first difference DE1 and the third distance S3. The above relationships are expressed in formulas (3) and (4) as follows:

S4<W3+S3 (3)

S4+W4>DE1+S3 (4)

To summarize, when the formulas (3) and (4) are satisfied, the second device electrode 106 of the electronic device 100 still maintains electrical contact with the second charging electrode 206 no matter the second device electrode 106 is moved to whatever position along the first direction D1.

In the present embodiment of the invention, the device electrode and the charging electrode satisfy formulas (1)˜(4). However, such exemplification is not for limiting the invention. In an implementation, the electronic device 100 still can be charged despite none or only some of formulas (1)˜(4) are satisfied. For example, the charging electrodes (the first and the second charging electrodes) and the detection electrodes (the first and the second detection electrode) are located within a fixed charging region of the placement surface 202a. The devices electrodes (the first, the second and the third device electrode) are disposed on the main machine 102 of the electronic device 100 and correspond to the charging electrodes of the charging device 200 within the fixed charging region. Thus, the device electrodes of the electronic device 100 still can electrically contact the charging electrodes of the charging device 200 as long as the electronic device 100 is placed within the fixed charging region of the placement surface 202a at each time of charging. The fixed charging region is such as the middle region or a corner region such as the top right, the bottom right, the top left or the bottom left of the placement surface 202a.

The first device electrode 104 and the second device electrode 106 can form a symmetric structure. For example, the first distance S1 is substantially equal to the third distance S3, and the first width W1 is substantially equal to the third width W3. Likewise, the first charging electrode 204 and the second charging electrode 206 can form a symmetric structure. For example, the second distance S2 is substantially equal to the fourth distance S4, and the second width W2 is substantially equal to the fourth width W4. With the symmetric structure, even the electronic device 100 of FIG. 3 is rotated around a direction perpendicular to the paper surface for 180 degrees, the first device electrode 104 maintains electrical contact with the second charging electrode 206 and so does the second device electrode 106 maintain electrical contact with the first charging electrode 204 no matter the electronic device 100 is moved to whatever position along the first direction D1. By this way, the polarity of the first charging electrode 204 and the polarity of the second charging electrode 206 should be switched accordingly, and the detailed would be descripted below.

Furthermore, the user only needs to place the electronic device 100 on the placement surface 202a without bothering about the orientation of electronic device 100, and the charging of the electronic device 100 will start immediately.

In the present embodiment of the invention, the dimensions of the device electrode are smaller than that of the charging electrode. However, such exemplification is not for limiting the invention. In other implementations, the dimensions of the device electrode of the electronic device can also be larger than that of the charging electrode of the charging device.

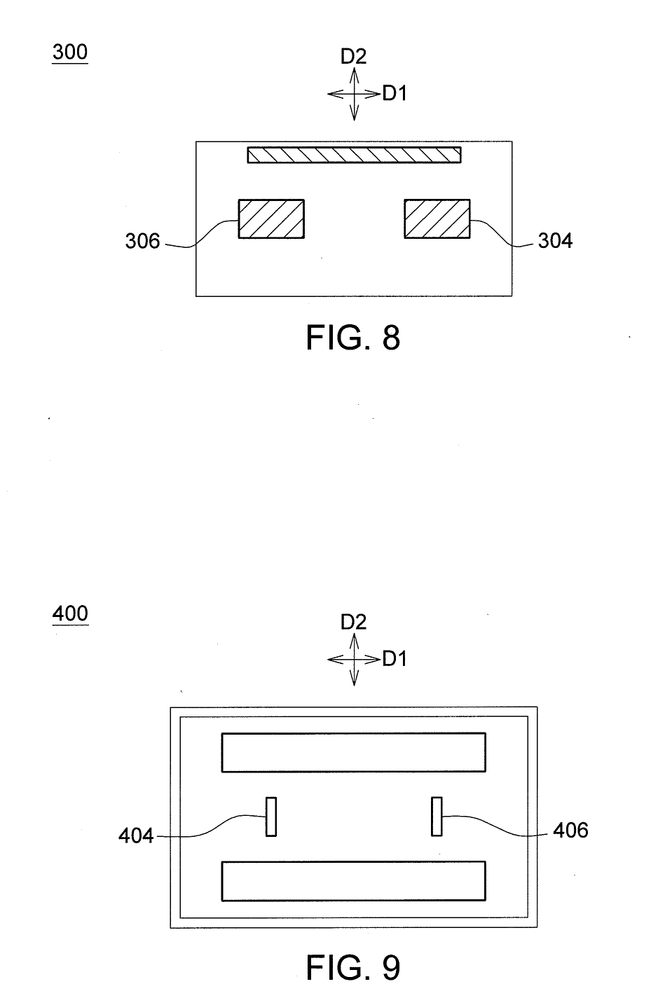

Referring to FIG. 8 and FIG. 9. FIG. 8 shows a bottom view of an electronic device according to an embodiment of the invention. FIG. 9 shows a top view of a charging device according to an embodiment of the invention. The dimensions of the first device electrode 304 of the electronic device 300 along the first direction D1 are larger than that of the first charging electrode 404 of the charging device 400 along a first direction D1. The dimensions of the second device electrode 306 of the electronic device 300 along the first direction D1 are larger than that of the second charging electrode 406 of the charging device 400 along the first direction D1. The placement and dimensions of the first device electrode 304 and the first charging electrode 404 can be designed according to the design principles of formulas (1)˜(2), and the placement and dimensions of the second device electrode 306 and the second charging electrode 406 can be designed according to the design principles of formulas (3)˜(4). Thus, the first device electrode 304 and the second device electrode 306 of the electronic device 300 both electrically contact the first charging electrode 404 and the second charging electrode 406 of the charging device 400 respectively no matter the electronic device 300 is moved to whatever region on the placement surface 402a of the charging device 400.

In the present embodiment of the invention, the quantity of the first device electrode of the electronic device is singular and so is the quantity of the second device electrode. In other implementations, the quantity of the first device electrode and the quantity of the second device electrode can respectively be plural. Or, the quantity of one of the first device electrode and the second device electrode can be plural but the quantity of the other of the first device electrode and the second device electrode can be singular. The embodiment of the invention does not exercise any specific restriction regarding the quantities of the first device electrode and the second device electrode. For example, at least one of the first device electrode 304 and the second device electrode 306 of FIG. 8 can be divided into a plurality of smaller sub-device electrodes.

The embodiment of the invention does not exercise any specific restriction regarding the quantities of the first charging electrode and the second charging electrode of the charging device. The quantity of the first charging electrode and the quantity of the second charging electrode can respectively be plural, or the quantity of one of the first charging electrode and the second charging electrode is plural but the quantity of the other of the first charging electrode and the second charging electrode is singular. For example, at least one of the first charging electrode 204 and the second charging electrode 206 of FIG. 2 can be divided into a plurality of smaller sub-charging electrodes.

The charging device 200 can switch the polarity of the first charging electrode 204 and the polarity of the second charging electrode 206 according to the third device electrode 108 electrically contacts the first detection electrode 208 or the second detection electrode 210 for enabling the polarity of the charging electrode to be conformed to the polarity of the device electrode of the electronic device so as to charge the electronic device 100. In details, the electronic device 100 may electrically contact the charging device 200 by moving the electronic device 100 to whatever position in the first direction D1 as indicated in FIG. 3 and FIG. 7 or being rotated for 180 degrees as descripted above, which means that apart from enabling the third device electrode 108 to contact the first detection electrode 208 as indicated in FIG. 3 and FIG. 7, the electronic device 100 can be rotated for 180 degrees for enabling the third device electrode 108 to contact the second detection electrode 210 for charging. Since the polarities of the first device electrode 104 and the second device electrode 106 are fixed (assuming the polarities of the first device electrode 104 and the second device electrode 106 of the electronic device 100 are respectively positive polarity and negative polarity), the polarity of the charging electrode needs to be switched, so that the polarity of the charging electrode is conformed to the polarity of the device electrode.

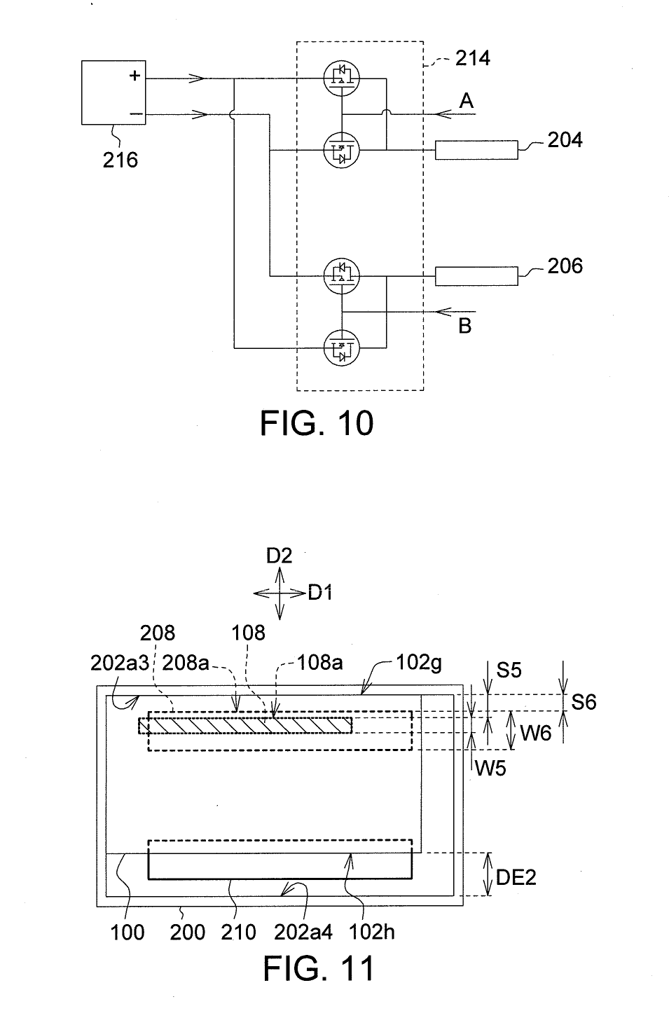

Referring to FIG. 10, a charging device according to an embodiment of the invention is shown. The charging device 200 further comprises a switch circuit 214 electrically connected to a power 216, a first charging electrode 204 and a second charging electrode 206. The power 216 can be realized by an external power or an internal power of the charging device 200. The switch circuit 214 comprises a plurality of transistors. For example, the switch circuit 214 comprises a plurality of P-type and N-type metal-oxide-semiconductor field-effect transistors (MOSFET).

The polarity of the first device electrode 104 is defined as a first polarity, and the polarity of the second device electrode 106 is defined as a second polarity and those are known and fixed. Once the third device electrode 108 contacts one of the first detection electrode 208 and the second detection electrode 210, it is confirmed at the same time that the first device electrode 104 and the second device electrode 106 respectively contact the first charging electrode 204 and the second charging electrode 206. Meanwhile, the switch circuit 214 directs the first polarity of the power 216 to the charging electrode which contacts the first device electrode 104, and directs the second polarity of the power 216 to the charging electrode which contacts the second device electrode 106. Let the polarity of the first device electrode 104 be the positive polarity and let the polarity of the second device electrode 106 be the negative polarity. As indicated in Table 1 below, when the first detection electrode 208 electrically contacts the third device electrode 108 (as indicated in FIG. 3), it is confirmed at the same time that the first device electrode 104 and the second device electrode 106 respectively contact the first charging electrode 204 and the second charging electrode 206. Meanwhile, the logic control enters state a. In state a, both the first control signal A and the second control signal B are logic 0, so that the positive polarity of the power 216 is directed to the first charging electrode 204 and the negative polarity of the power 216 is directed to the second charging electrode 206. That is, the polarities are respectively conformed to the polarities of the corresponding first device electrode 104 and second device electrode 106. When the second detection electrode 210 electrically contacts the third device electrode 108 (for example, the electronic device 100 of FIG. 3 is rotated around a direction perpendicular to the paper surface for 180 degrees and then is again placed on the placement surface 202a), it is confirmed at the same time that the first device electrode 104 and the second device electrode 106 respectively contact the second charging electrode 206 and the first charging electrode 204. Meanwhile, the logic control enters state c, and both the first control signal A and the second control signal B are logic 1, so that the negative polarity of the power 216 is directed to the first charging electrode 204 and the positive polarity of the power 216 is directed to the second charging electrode 206. That is, the polarities are respectively conformed to the polarities of the corresponding second device electrode 106 and the first device electrode 104.

Moreover, when the first detection electrode 208 and the second detection electrode 210 do not electrically contact the third device electrode 108 (do not enter the charging state), the logic control enters state b, the first control signal A is logic 1 and the second control signal B is logic 0, so that there is no voltage difference between the first charging electrode 204 and the second charging electrode 206. Such a safety mechanism avoids the first charging electrode 204 and the second charging electrode 206 being damaged or burnt by short-circuiting which occurs when a conductor (such as a conductive liquid) is poured to the placement surface 202a by mistake, and also avoids the human body being injured by electrical shot which occurs when the human body touches the placement surface 202a.

TABLE 1

| | | | First Charging | Second Charging |
|---|---|---|---|---|
| | A | B | Electrode | Electrode |
| a | 0 | 0 | + | − |
| c | 1 | 0 | − | − |
| d | 1 | 1 | − | + |

The placement and dimensions of the third device electrode and the first detection electrode are disclosed below.

Referring to FIG. 11, a top view of the electronic device of FIG. 3 being moved to a third boundary of a placement surface is shown. The length of the placement surface 202a along a second direction D2 (the width direction of the main machine) differs with the length of the main machine 102 along the second direction D2 by a second difference DE2, wherein the second direction D2 is substantially perpendicular to the first direction D1. The placement surface 202a has a third boundary 202a3 and a fourth boundary 202a4 opposite to the third boundary 202a3. The main machine 102 has a third main machine lateral surface 102g and a fourth main machine lateral surface 102h opposite to the third main machine lateral surface 102g, wherein the third main machine lateral surface 102g and the fourth main machine lateral surface 102h are both located between the first main machine lateral surface 102c and the second main machine lateral surface 102d. The third device electrode 108 has a fifth width W5 and a third device electrode lateral surface 108a which faces the third main machine lateral surface 102g. The third device electrode lateral surface 108a is separated from the third main machine lateral surface 102g by a fifth distance S5. The first detection electrode 208 disposed adjacent to the third boundary 202a3 has a sixth width W6 and a first detection electrode lateral surface 208a which faces the third boundary 202a3. The first detection electrode lateral surface 208a is separated from the third boundary 202a3 by a sixth distance S6. The sixth distance S6 is smaller than the sum of the fifth distance S5 and the fifth width W5 of the third device electrode 108. The sum of the sixth distance S6 and the sixth width W6 is larger than the sum of the second difference DE2 and the fifth distance S5. The above relationships are expressed in formulas (5) and (6) as follows:

S6<W5+S5 (5)

S6+W6>DE2+S5 (6)

To summarize, when the formula (5) is satisfied, the third device electrode 108 still electrically contacts the first detection electrode 208 and will not be electrically separated from the first detection electrode 208 despite the third main machine lateral surface 102g of the electronic device 100 is aligned with the third boundary 202a3 of the placement surface 202a.

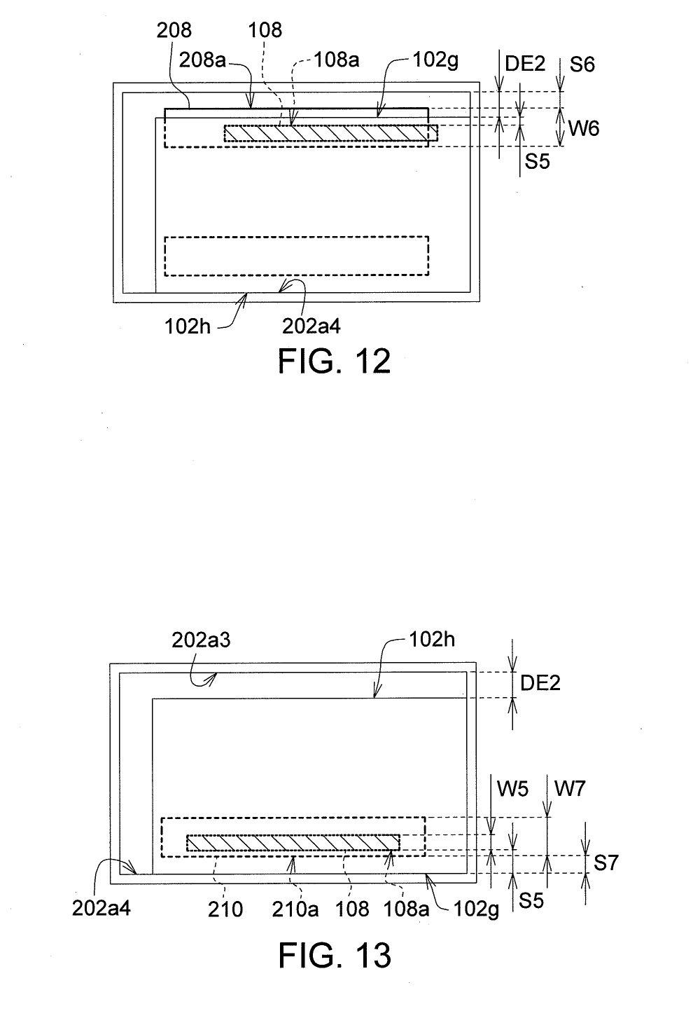

Referring to FIG. 12 (not illustrated the display surface), a top view of the electronic device of FIG. 11 being moved to a fourth boundary of a placement surface is shown. When the formula (6) is satisfied, the third device electrode 108 at least electrically contacts the first detection electrode 208, and will not be electrically separated from the first detection electrode 208 despite the fourth main machine lateral surface 102h of the electronic device 100 is aligned with the fourth boundary 202a4 of the placement surface 202a as illustrated in FIG. 12. The third boundary 202a3 and the fourth boundary 202a4 are opposite to each other.

To summarize, when the formulas (5) and (6) are satisfied, given that the third device electrode 108 electrically contacts the first detection electrode 208, the third device electrode 108 of the electronic device 100 still maintains electrical contact with the first detection electrode 208 no matter the third device electrode 108 is moved to whatever position along the second direction D2.

Given that the electronic device 100 of FIG. 11 or 12 is rotated around a direction perpendicular to the paper surface for 180 degrees and then is again placed on the placement surface 202a, the placement and dimensions of the second detection electrode 210 and the third device electrode 108 are similar to the dimension relationships of the formulas (5) and (6).

Referring to FIG. 13 (not illustrated the display surface), another placement of the electronic device of FIG. 3 is shown. The second detection electrode 210 of the charging device 200 disposed adjacent to the fourth boundary 202a4 has a seventh width W7 and a second detection electrode lateral surface 210a which faces the fourth boundary 202a4. The second detection electrode lateral surface 210a is separated from the fourth boundary 202a4 by a seventh distance S7. The seventh distance S7 is smaller than the sum of the fifth distance S5 and the fifth width W5 of the third device electrode 108, and the sum of the seventh distance S7 and the seventh width W7 is larger than the sum of the second difference DE2 and the fifth distance S5. The above relationships are expressed in formulas (7) and (8) as follows:

S7<W5+S5 (7)

S7+W7>DE2+S5 (8)

When the dimension relationship of formula (7) is satisfied, the third device electrode 108 at least electrically contacts the second detection electrode 210 and will not be electrically separated from the second detection electrode 210 despite the third main machine lateral surface 102g of the electronic device 100 is aligned with the fourth boundary 202a4 of the placement surface 202a as illustrated in FIG. 13.

When the dimension relationship of formula (8) is satisfied, the third device electrode 108 at least electrically contacts the second detection electrode 210 and will not be electrically separated from the second detection electrode 210 despite the fourth main machine lateral surface 102h of the electronic device 100 is aligned with the third boundary 202a3 of the placement surface 202a as illustrated in FIG. 13.

To summarize, when the formulas (7) and (8) are both satisfied, given that the third device electrode 108 electrically contacts the second detection electrode 210, the third device electrode 108 of the electronic device 100 still maintains electrical contact with the second detection electrode 210 no matter the third device electrode 108 is moved to whatever position along the second direction D2.

In an embodiment, the first detection electrode and the second detection electrode of the charging device can form a symmetric structure. Referring to FIG. 11 and FIG. 13. The sixth distance S6 is substantially equal to the seventh distance S7, and the sixth width W6 of the first detection electrode 208 is substantially equal to the seventh width W7 of the second detection electrode 210.

In the present embodiment of the invention, the electronic device comprises a third device electrode. However, in other implementations, the electronic device 100 still can be charged in the absence of the third device electrode 108. Under such circumstances, the first detection electrode 208 and the second detection electrode 210 can also be omitted.

In an embodiment, the dimensions and dispositions of the third device electrode 108 and the first detection electrode 208 along the first direction D1 (such as the relationship between the distance to the first boundary 202a1 and the distance to the second boundary 202a2) can be designed according to the design principles of formulas (1)˜(4), so that the third device electrode 108 still maintains electrical contact with the first detection electrode 208 or the second detection electrode 210 no matter the third device electrode 108 is moved to whatever position along the first direction D1.

Also, the first device electrode 104, the second device electrode 106, the dimensions and dispositions of the first charging electrode 204 and the second charging electrode 206 along the second direction D2 (such as the relationship between the distance to the third boundary 202a3 and the distance to the fourth boundary 202a4) can be designed according to according to the design principles of formulas (5)˜(8). Thus, the first device electrode 104 still maintains electrical contact with the first charging electrode 204 or the second charging electrode 206 no matter the first device electrode 104 is moved to whatever position along the second direction D2; the second device electrode 106 still maintains electrical contact with the first charging electrode 204 or the second charging electrode 206 no matter the second device electrode 106 is moved to whatever position along the second direction D2.

The charging device, the electronic device and the electronic device module using the same disclosed in the above embodiments of the invention have many features exemplified below:

(1). The charging electrodes of the charging device are distributed on the placement surface with a larger area and the distribution area is also larger, so that the electronic device can be easily placed on the placement surface of the charging device for charging.

(2). The device electrodes of the electronic device are distributed on the charging surface with a larger area and the distribution area is also larger, so that the electronic device can be easily placed on the placement surface of the charging device for charging.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic device for being placed on a charging device for charging, wherein the charging device comprises a first charging electrode, a second charging electrode and a placement surface, and the electronic device comprises:
a main machine having a display surface and a charging surface opposite to the display surface;
a first device electrode having a first polarity and being located on the charging surface; and
a second device electrode having a second polarity and being located on the charging surface;
wherein, the main machine is charged in such way that the first device electrode placed on one of the first charging electrode and the second charging electrode and the second device electrode placed on the other of the first charging electrode and the second charging electrode.

2. The electronic device according to claim 1, wherein the main machine has a first main machine lateral surface, and the first device electrode disposed is adjacent to the first main machine lateral surface and has a first width and a first device electrode lateral surface which is separated from the first main machine lateral surface by a first distance; the length of the placement surface along a first direction differs with the length of the main machine along the first direction by a first difference, the placement surface has a first boundary, and the first charging electrode disposed is adjacent to the first boundary and has a second width and a first charging electrode lateral surface which is separated from the first boundary by a second distance;
wherein, the second distance is smaller than the sum of the first distance and the first width of the first device electrode, and the sum of the second distance and the second width is larger than the sum of the first difference and the first distance.

3. The electronic device according to claim 2, wherein the main machine has a second main machine lateral surface opposite to the first main machine lateral surface, the second device electrode disposed is adjacent to the second main machine lateral surface and has a third width and a second device electrode lateral surface which is separated from the second main machine lateral surface by a third distance, the placement surface has a second boundary opposite to the first boundary, and the second charging electrode disposed is adjacent to the second boundary and has a fourth width and a second charging electrode lateral surface which is separated from the second boundary by a fourth distance;
wherein, the fourth distance is smaller than the sum of the third distance and the third width of the second device electrode, and the sum of the fourth distance and the fourth width is larger than the sum of the first difference and the third distance.

4. The electronic device according to claim 1, wherein the length of the placement surface along a second direction differs with the length of the main machine along the second direction by a second difference, the second direction is substantially perpendicular to the first direction, the main machine further has a third main machine lateral surface which is located between the first main machine lateral surface and the second main machine lateral surface, and the electronic device further comprises:
a third device electrode having a fifth width and a third device electrode lateral surface, wherein the third device electrode lateral surface is separated from the third main machine lateral surface by a fifth distance, the charging device further comprises a first detection electrode, the placement surface has a third boundary, and the first detection electrode disposed is adjacent to the third boundary and has a sixth width and a first detection electrode lateral surface which is separated from the third boundary by a sixth distance;
wherein, the sixth distance is smaller than the sum of the fifth distance and the fifth width of the third device electrode, and the sum of the sixth distance and the sixth width is larger than the sum of the second difference and the fifth distance.

5. The electronic device according to claim 4, wherein the charging device further has a fourth boundary opposite to the third boundary and further comprises a second detection electrode which is disposed adjacent to the fourth boundary and has a seventh width and a second detection electrode lateral surface which is separated from the fourth boundary by a seventh distance;
wherein, the seventh distance is smaller than the sum of the fifth distance and the fifth width, and the sum of the seventh distance and the seventh width is larger than the sum of the second difference and the fifth distance.

6. The electronic device according to claim 5, wherein the charging device further comprises a switch circuit.

7. The electronic device according to claim 6, wherein the switch circuit of the charging device switches the polarity of the first charging electrode and the polarity of the second charging electrode according to the third device electrode being contacting one of the first detection electrode and the second detection electrode and.

8. The electronic device according to claim 7, wherein the first device electrode and the second device electrode are formed by a conductive rubber.

9. A charging device for providing power to an electronic device which comprises a main machine, a first device electrode and a second device electrode, wherein the main machine has a display surface and a charging surface opposite to the display surface, the first device electrode and the second device electrode are both located on the charging surface, and the charging device comprises:
a body having a placement surface on which the electronic device is placed;
a first charging electrode located within the placement surface of the body; and
a second charging electrode located within the placement surface of the body;
wherein, the main machine is charged in such way that the first device electrode placed on one of the first charging electrode and the second charging electrode and the second device electrode placed on the other of the first charging electrode and the second charging electrode.

10. An electronic device module, comprising:
an electronic device, comprising:
a main machine having a display surface and a charging surface opposite to the display surface;
a first device electrode located on the charging surface; and
a second device electrode located on the charging surface; and
a charging device, comprising;
a body having a placement surface on which the electronic device is placed; and
a first charging electrode located within the placement surface of the body;
a second charging electrode located within the placement surface of the body;
wherein, the main machine is charged in such way that the first device electrode placed on one of the first charging electrode and the second charging electrode and the second device electrode placed on the other of the first charging electrode and the second charging electrode.
